(19) United States
(12) Patent Application Publication
(10) Pub. No.: US 2011/0212661 A1
(43) Pub. Date: Sep. 1, 2011

(54) METHOD AND APPARATUS FOR MANUFACTURING TOUCH SCREEN

(76) Inventors: Jong Young LEE, Gyunggi-do (KR); Young Soo Oh, Gyunggi-do (KR); Woon Chun Kim, Gyunggi-do (KR); Ho Joon Park, Seoul (KR); Sang Hwa Kim, Gyunggi-do (KR); Yong Hyun Jin, Seoul (KR); Kyoung Soo Chae, Gyunggi-do (KR)

(21) Appl. No.: 12/760,961

(22) Filed: Apr. 15, 2010

(30) Foreign Application Priority Data
Feb. 26, 2010 (KR) 10-2010-0017847

(51) Int. Cl. H01J 9/00

(52) U.S. Cl. 445/24; 445/67

(57) ABSTRACT

Disclosed herein is a method of manufacturing a touch screen, including: supplying a PET film; supplying and printing transparent conductive polymer electrodes on both sides of the PET film; printing conductive patterns on the transparent conductive polymer electrodes; supplying an adhesive to the transparent conductive polymer electrodes to form an adhesive layer; supplying a protective film to the adhesive layer; and cutting a laminate composed of the PET film, the printed transparent conductive polymer electrodes, the conductive patterns, the adhesive layer and the protective film. The method is advantageous in that a touch screen can be manufactured by an automated process using a roll-type feed or a sol-type feeder.

### CROSS REFERENCE TO RELATED APPLICATION

This application claims the benefit of Korean Patent Application No. 10-2010-0017847, filed Feb. 26^{th} 2010, entitled “The method and apparatus for the production of touch screen”, which is hereby incorporated by reference in its entirety into this application.

### BACKGROUND OF THE INVENTION

1. Technical Field

The present invention relates to a method and apparatus for manufacturing a touch screen using an automated process.

2. Description of the Related Art

Recently, touch screens for inputting signals into electronic products by touching screens have been generally used in accordance with users' requirements for the convenient use of electronic products. Touch screens have many advantages in that it can easily work side by side with IT equipment in addition to the advantages of being able to save space, improve operability and convenience, and the specifications being easy to change, thus increasing their recognition among users. Due to these advantages, touch screens are widely used in various fields, such as industry transportation, service, medical, mobile and the like.

Such a touch screen can be manufactured by a variety of methods, such as a resistive overlay method in which a glass substrate is coated with resistive components and then covered with a polyethylene film; a capacitive overlay method in which a transparent conductive metal is applied on both sides of a heat-treated reinforced glass substrate; an integral overlay method in which infrared luminescent diodes emitting infrared beams and strain gauges measuring the extensibility of four corners of a substrate are used; a surface ultrasonic conductive overlay method in which an ultrasonic transmitter is disposed at one edge of a glass substrate, an ultrasonic receiver is disposed at the other edge of the glass substrate, and ultrasonic reflectors are disposed between the ultrasonic transmitter and the ultrasonic receiver at regular intervals; and a piezoelectric overlay method in which a pressure-sensitive crystal oscillator is provided at the corner of a display panel in order to detect being touched.

However, a conventional method of manufacturing a touch screen cannot be performed automatically because a process of connecting flexible printed cables (FPCs) must be previously performed. This also therefore means that many workers are required to manufacture a touch screen.

More concretely, FIG. 1 is a schematic plan view showing a conventional touch screen manufactured by a resistive overlay method. As shown in FIG. 1, the touch screen 10 include a conductive pattern printing unit 11 and flexible printed cables (FPCs) 12 connected to the conductive pattern printing unit 11.

As described above, in order to connect the flexible printed cables 12 to the conductive pattern printing unit 11, first, the cover of the conductive pattern printing unit 11 must be removed to expose the conductive pattern printing unit, and, simultaneously, a process of forming through-holes must be performed. Therefore, this touch screen 10 manufactured by a resistive overlay method is problematic in that its productivity decreases and its production cost increases.

Further, FIG. 2 is a schematic sectional view showing a conventional touch screen manufactured by a capacitive overlay method. As shown in FIG. 2, the touch screen 20 includes: a liquid crystal display (LCD) panel 21; and an optical clear adhesive (OCA) layer 22, a hard coating layer 23, a primer layer 24, a polyethylene terephthalate (PET) film 25, a primer layer 24, a hard coating layer 23, a primer layer 24, a transparent ground electrode 26, an OCA layer 22, a hard coating layer 23, a primer layer 24, a PET film 25, a primer layer 24, a hard coating layer 23, a primer layer 24, a transparent electrode 26, a printed Ag electrode 27, an OCA layer 22, a printed Ag electrode 27, a transparent electrode 26, a primer layer 24, a hard coating layer 23, a primer layer 24, a PET film 25, a primer layer 24, a hard coating layer 23, an OCA layer 22, a cover (window) sheet 28, a primer layer 24 and a hard coating layer 23, which are sequentially formed on the liquid crystal display (LCD) panel 21.

As described above, this touch screen 20 manufactured by a capacitive overlay method, similarly to the touch screen 10 manufactured by a resistive overlay method, is problematic in that flexible printed cables 12 must be connected to Ag electrodes as electric wires after a worker removes the cover of the Ag electrode in a non-automated manner, thus decreasing productivity and increasing production cost.

### SUMMARY OF THE INVENTION

Accordingly, the present invention has been devised with the intention of solving the above-mentioned problems, and the present invention provides a method and apparatus for manufacturing a touch screen, which can be automated by a roll-type feeder or a sol-type feeder.

Further, the present invention provides a method and apparatus for manufacturing a touch screen, which can solve the problem of it being difficult to machine one side of the touch screen while protecting the other side thereof, and which can realize a machining process together with a printing process.

Further, the present invention provides a method and apparatus for manufacturing a touch screen, which can efficiently improve the productivity of the touch screen by controlling the rotation speed of a roll-type feeder, and which can produce the touch screen in large amounts as finished goods.

Furthermore, the present invention provides a method and apparatus for manufacturing a touch screen, in which a conductive polymer film having conductivity, moisture resistance, heat resistance, durability and stability to contraction can be prepared by a sufficient drying process, thus improving the performance of the touch screen.

An aspect of the present invention provides a method of manufacturing a touch screen, including: supplying a PET film; supplying and printing transparent conductive polymer electrodes on both sides of the PET film; printing conductive patterns on the transparent conductive polymer electrodes; supplying an adhesive to the transparent conductive polymer electrodes to form an adhesive layer; supplying a protective film to the adhesive layer; and cutting a laminate composed of the PET film, the printed transparent conductive polymer electrodes, the conductive patterns, the adhesive layer and the protective film.

Here, the method of manufacturing a touch screen may further include: cutting a predetermined portion of the adhesive layer, the predetermined portion corresponding to a position at which flexible printed cables are connected to the conductive patterns.

Further, the adhesive layer may be made of one selected from among an optical clear adhesive (OCA) or a liquid adhesive.

Further, the supplying of the PET film, the supplying of the transparent conductive polymer electrodes, the supplying of the adhesive and the supplying of the protective film may be performed by a roll-type feeder or a sol-type feeder.

Further, the transparent conductive polymer electrodes may be printed on the PET film such that each of the transparent conductive polymer electrodes is composed of a plurality of electrode units which are arranged to have a stripe pattern or no pattern in order to improve transparency and each of the electrode units has one shape selected from among diamond, bar, cone, triangle, ellipse, square, rectangle, circle and polygon shapes.

Further, the conductive patterns may be formed of one selected from among Ag-paste, a conductive polymer, gold, and a nanosized conductive material.

Further, the printing of the conductive patterns is performed by a coating roll or a silk screen.

Further, the method of manufacturing a touch screen may further include: vertically hot-pressing the transparent conductive polymer electrodes after the printing of the conductive patterns.

Further, the method of manufacturing a touch screen may further include: drying the transparent conductive polymer electrodes after the supplying and printing of the transparent conductive polymer electrodes and after the printing of the conductive patterns.

Further, the drying of the transparent conductive polymer electrodes may be performed at a temperature of 60˜150 for 1˜30 minutes, and may be performed using any one selected from among hot drying, UV drying, IR drying and combinations thereof.

Further, the method of manufacturing a touch screen may further include: supplying a window sheet to the adhesive between supplying of the adhesive and the supplying of the protective film. Therefore, this method may be used to manufacture a touch screen for mobile phones.

Further, the window sheet may be formed of at least one selected from among a hard coating layer, a PET film, a primer layer, a printing and black masking layer, an anti-finger layer, an anti-refractive layer and an antireflective layer.

Further, the method of manufacturing a touch screen may further include: supplying a sheet to the adhesive between supplying of the adhesive and the supplying of the protective film. Therefore, this method may be used to manufacture a touch screen for monitors.

Further, the sheet may be formed of any one selected from among a hard coating layer, an anti-refractive layer, an antireflective layer, and combinations thereof.

Further, the method of manufacturing a touch screen may further include: forming a hard coating layer on at least one side of the PET film using a coating roll before the supplying of the transparent conductive polymer electrodes.

Another aspect of the present invention provides an apparatus for manufacturing a touch screen, including: a PET film supply unit for supplying a PET film; a transparent conductive polymer electrode supply and printing unit for forming a transparent conductive polymer electrode on the PET film; a conductive pattern printing unit for printing a conductive pattern on the transparent conductive polymer electrode; a drying chamber for drying the PET film, the transparent conductive polymer electrode and the conductive pattern; an adhesive supply unit for supplying an adhesive to the transparent conductive polymer electrode to form an adhesive layer; a protective film supply unit for supplying a protective film to the adhesive layer and the conductive pattern; and a cutting unit for cutting a laminate composed of the PET film, the printing transparent conductive polymer electrode, the conductive pattern, the adhesive layer and the protective film.

Here, the apparatus for manufacturing a touch screen may further include: a cutting unit for cutting a predetermined portion of the adhesive layer, the predetermined portion corresponding to a position at which flexible printed cables are connected to the conductive pattern.

Further, the supplying of the PET film, the supplying of the transparent conductive polymer electrode, the supplying of the adhesive and the supplying of the protective film may be performed by a roll-type feeder or a sol-type feeder.

Further, the transparent conductive polymer electrode may be formed by sequentially printing and laminating a transparent electrode, a transparent insulator and a transparent conductive polymer electrode on a hard substrate composed of a flexible film such as a PET (polyethyleneterephthalate) or PEN (polyethylene naphthalate) film, glass, reinforced glass, PMMA (polymethylmethacrylate), PC (polycarbonate), COC (cyclic olefin copolymer) and BOPS (biaxially oriented polystyrene).

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic plan view showing a conventional touch screen manufactured by a resistive overlay method;

FIG. 2 is a schematic sectional view showing a conventional touch screen manufactured by a capacitive overlay method;

FIG. 3 is a schematic view showing an apparatus for manufacturing a touch screen according to a first embodiment of the present invention;

FIG. 4 is a schematic flowchart showing a method of manufacturing a touch screen according to a first embodiment of the present invention;

FIG. 5 is a schematic sectional view showing a touch screen manufactured by the method shown in FIG. 4;

FIG. 6 is a schematic view showing an apparatus for manufacturing a touch screen according to a second embodiment of the present invention;

FIG. 7 is a schematic view showing an apparatus for manufacturing a touch screen according to a third embodiment of the present invention;

FIG. 8 is a schematic view showing a process of printing a transparent conductive polymer electrode in the method of manufacturing a touch screen according to the present invention;

FIG. 9 is a schematic view showing a transparent conductive polymer electrode printed by the printing process shown in FIG. 8;

FIG. 10 is a schematic view showing a transparent conductive polymer electrode obtained by printing an insulation layer on the transparent conductive polymer electrode shown in FIG. 9; and

FIG. 11 is a schematic view showing a transparent conductive polymer electrode obtained by printing a conductive polymer layer on the transparent conductive polymer electrode shown in FIG. 10.

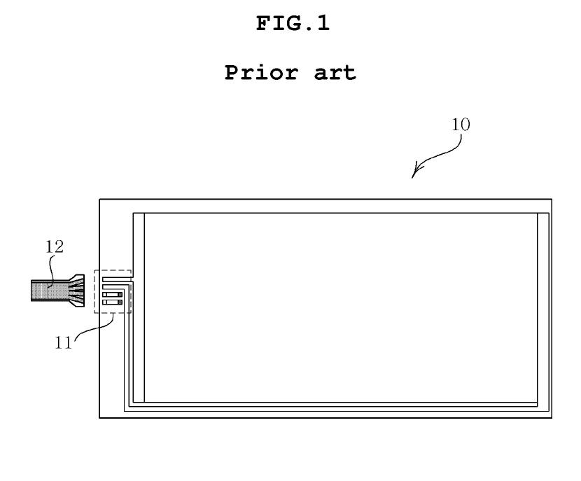

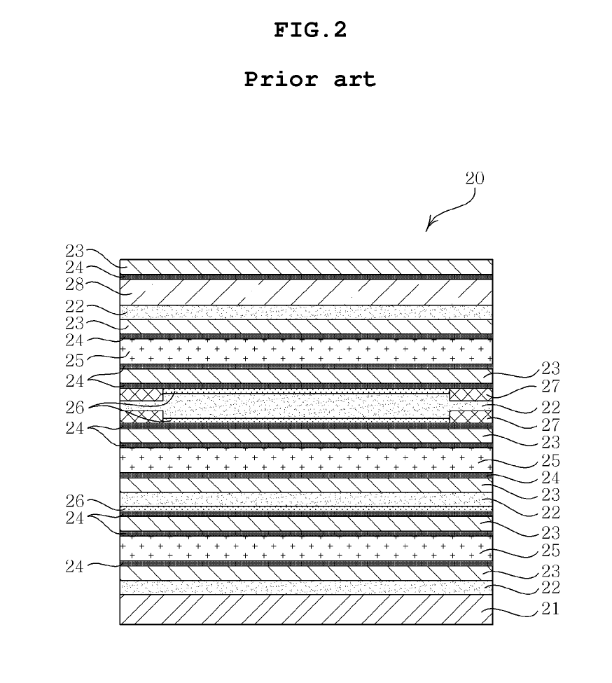

### DESCRIPTION OF THE PREFERRED EMBODIMENTS

The objects, features and advantages of the present invention will be more clearly understood from the following detailed description and preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, a preferred embodiment of the present invention will be described in detail with reference to the attached drawings.

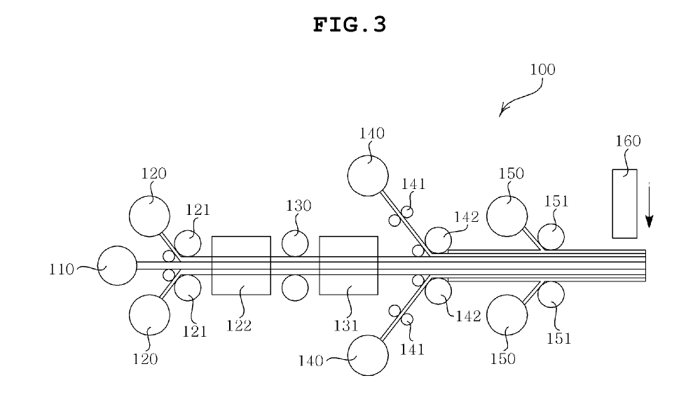

FIG. 3 is a schematic view showing an apparatus for manufacturing a touch screen according to a first embodiment of the present invention. As shown in FIG. 3, the apparatus 100 for manufacturing a touch screen includes a PET (polyethylene terephthalate) film supply unit 110, transparent conductive polymer electrode supply units 120, transparent conductive polymer electrode printing units 121, conductive pattern printing units 130, drying chambers 122 and 131, adhesive supply units 140, flexible printed cable connection hole forming units 141, protective film supply units 150, and a cutting unit 160.

In the apparatus 100 for manufacturing a touch screen, in order to manufacture a touch screen having a laminate structure in which its constituents face each other based on one PET film, the supply units make their respective pairs such that each pair of supply units face each other.

Further, each of the PET film supply unit 110, the transparent conductive polymer electrode supply units 120, the adhesive supply units 140 and the protective film supply units 150 uses any one selected from among a roll-type feeder and a sol-type feeder, and its raw material is supplied using a rotating roll.

Meanwhile, when the adhesive supply units 140 supply a liquid adhesive instead of a sol-type adhesive, a printing roll may be used instead of the rotating roll.

Further, the adhesive supply units 140 supply the adhesive in the form of an optical clear adhesive (OCA) film or a liquid conductive polymer material. That is, the adhesive may be supplied in the form of a roll-type film or a liquid adhesive for a coating roll.

The apparatus 100 for manufacturing a touch screen further includes hot press rotating rolls 142 and press rotating rolls 151. Here, the press rotating rolls 151, as shown in FIG. 6, may be replaced by hot press rotating rolls 351 when a window sheet is supplied by a window sheet supply unit 370.

Further, in order to easily connect flexible printed cables to the conductive pattern printing unit, flexible printed cable connection holes may be formed at a predetermined portion of the adhesive layer, the predetermined portion corresponding to a flexible printed cable connector, using the flexible printed cable connection hole forming units 141.

Therefore, the apparatus for manufacturing a touch screen according to the present invention is advantageous in that the problem of it being difficult to machine one side of the touch screen while protecting the other side thereof can be solved, in that a machining process and a printing process can be simultaneously performed, and in that flexible printed cables can be automatically cut, and can be connected to the conductive pattern printing unit without performing additional work.

Further, FIG. 3 shows an apparatus for manufacturing a two-layered touch screen. This apparatus for manufacturing a two-layered touch screen may be modified into an apparatus for manufacturing a three-layered touch screen by additionally providing supply lines. This apparatus for manufacturing a three-layered touch screen can be easily realized by those skilled in the art, and also belongs to the scope of the present invention.

Hereinafter, methods of manufacturing a touch screen according to the present invention will be described in detail.

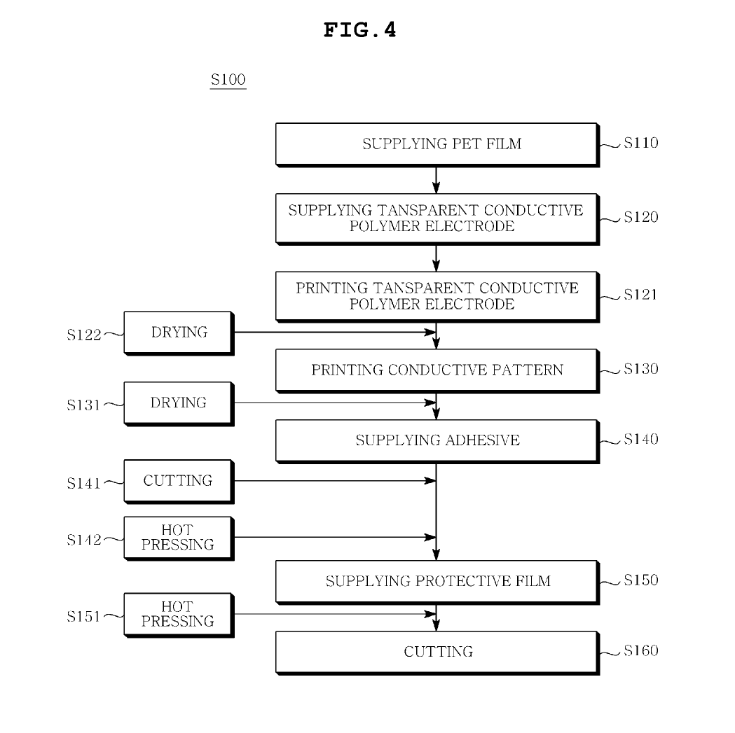

FIG. 4 is a schematic flowchart showing a method of manufacturing a touch screen according to a first embodiment of the present invention. As shown in FIG. 4, a process (S100) of manufacturing a touch screen includes the steps of: supplying a PET film using a PET film supply unit 110 (S110); supplying transparent conductive polymer electrodes to both sides of the PET film using transparent conductive polymer electrode supply units (S120); and printing the transparent conductive polymer electrodes on the both sides of the PET film using transparent conductive polymer electrode printing units (S121). Here, the printed transparent conductive polymer electrodes serve as upper and lower electrodes, respectively.

Further, a method of forming the transparent conductive polymer electrode, as disclosed in Korean Patent Application No. 2009-084210 filed by the present assignee, includes the steps of: providing an organic conductive composition containing a conductive material, a binder, a solvent and water; applying the organic conductive composition on a substrate to form a conductive film thereon and then heat-treating the conductive film; dicing the substrate coated with the conductive film into unit cells. Therefore, it is possible to perform pattern printing depending on the size of the transparent conductive polymer electrode to be manufactured. In particular, the organic conductive composition may have a viscosity of 30 cps or more when it is used to manufacture a one-sided or double-sided touch screen, and may have a viscosity of 30 cps or less when it is printed by an ink-jet printer.

Further, the transparent conductive polymer electrode according to the present invention is formed by sequentially printing and laminating a transparent electrode, a transparent insulator and a transparent conductive polymer electrode on a hard substrate composed of a flexible film such as a PET (polyethyleneterephthalate) or PEN (polyethylene naphthalate) film, glass, reinforced glass, PMMA (polymethylmethacrylate), PC (polycarbonate), COC (cyclic olefin copolymer) and BOPS (biaxially oriented polystyrene).

Subsequently, the laminated PET film and transparent conductive polymer electrode are transported to a drying chamber 122 and then dried in the drying chamber 122 (S122). Then, a conductive pattern is printed on the transparent conductive polymer electrode by conductive pattern printing units 130 such that electrode wires which can be connected with flexible printed cables are connected to the transparent conductive polymer electrode (transparent conductive polymer electrode having fragmented patterns) (S130).

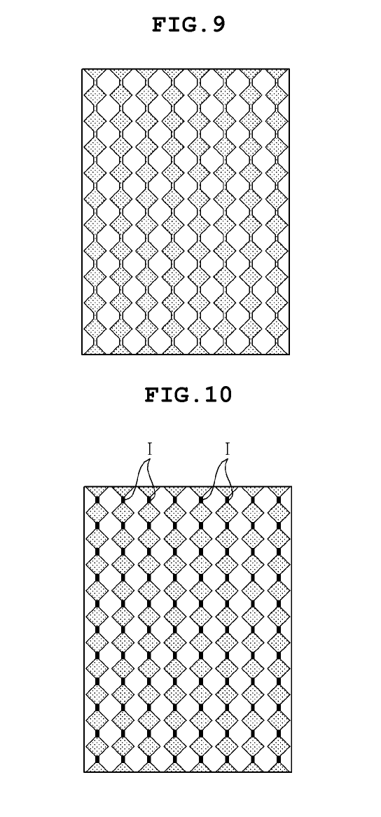

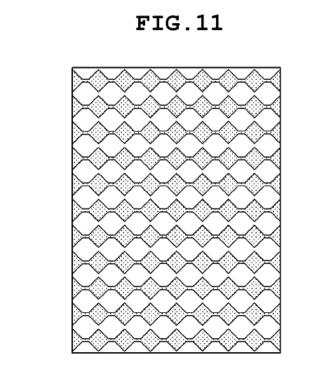

Meanwhile, FIG. 8 is a schematic view showing a process of printing a transparent conductive polymer electrode in the method of manufacturing a touch screen according to the present invention, FIG. 9 is a schematic view showing a transparent conductive polymer electrode printed by the printing process shown in FIG. 8, FIG. 10 is a schematic view showing a transparent conductive polymer electrode obtained by printing an insulation layer on the transparent conductive polymer electrode shown in FIG. 9, and FIG. 11 is a schematic view showing a transparent conductive polymer electrode obtained by printing a conductive polymer layer on the transparent conductive polymer electrode shown in FIG. 10.

More concretely, in order to print all of transparent conductive polymer electrodes on a one-layer film, first, a transparent electrode corresponding to an X-axis electrode is printed on a PET film 50 using an ink-jet printer 30 (refer to FIG. 9), and then a transparent insulation layer is printed on the cross region (I) of the printed transparent electrode (refer to FIG. 10), and then a transparent conductive polymer electrode corresponding to a Y-axis electrode is printed on the transparent electrode printed thereon with the transparent insulation layer (refer to FIG. 11), thereby printing a transparent conductive polymer electrode 40.

Also, the transparent conductive polymer electrodes are printed on the PET film such that each of the transparent conductive polymer electrodes is composed of a plurality of electrode units which are arranged to have a stripe pattern or no pattern in order to improve transparency and each of the electrode units has one shape selected from among diamond, bar, cone, triangle, ellipse, square, rectangle, circle and polygon shapes.

Further, instead of the PET film, a flexible film such as a PEN film, or a hard film composed of glass, reinforced glass, PMMA, PC, COC or BOPS may be used.

Further, the conductive pattern is made of any one selected from among Ag-paste, a conductive polymer material, gold and a nanosized conductive material, and is printed by roll coating or silk screening. Further, the conductive pattern may be printed along both edges of the transparent conductive polymer electrode that is a subject of printing.

Subsequently, a laminate of the PET film printed with the conductive pattern and the transparent conductive polymer electrode is transported into a drying chamber 131 and then dried in the drying chamber 131 (S 131). The drying processes (S122 and S131) are performed in order to allow the conductive polymer film to have uniform conductivity, moisture resistance, heat resistance, durability and stability to contraction, and may be conducted at a temperature of 60˜150 for 1˜30 minutes. Further, the drying processes (S122 and 5131) may be performed using any one selected from among hot drying, UV drying, IR drying and combinations thereof.

Subsequently, an adhesive is supplied to the dried laminate by the adhesive supply unit 140 to form an adhesive layer (S140). Then, the adhesive layer, the predetermined part of which corresponds to the position at which flexible printed cables are connected to the conductive pattern, is cut by the flexible printed cable connection hole forming units 141, and, particularly, the adhesive layer is cut such that it does stick to the flexible printed cables when it is realized by roll printing (S141). Then the cut adhesive layer is vertically hot-pressed by the hot press rotating roll 142 (S142).

Further, in the present invention, an optical clear adhesive (OCA) or a transparent adhesive may be used as the adhesive.

Subsequently, a protective film is supplied to the adhesive layer by the protective film supply unit 150 (S150), and then a touch screen sequentially including the PET film, the transparent conductive polymer electrode, the conductive pattern, the adhesive layer and the protective film is cut by a cutting unit 160 (S160).

Further, the method of manufacturing a touch screen according to the present invention may include the step of forming a hard coating layer using a coating roll (not shown) between the step (S130) of printing the conductive pattern and the step (S150) of supplying the protective film.

Further, the method of manufacturing a touch screen according to the present invention may include the step (S151) of vertically pressing the touch screen using the press rotating roll 151 (S151).

As described above, the method of manufacturing a touch screen according to the present invention is advantageous in that the method can be automated by a roll-type feeder or a sol-type feeder, in that the productivity of the touch screen can be efficiently improved by controlling the rotation speed of a roll-type feeder, and in that the touch screen can be produced in large amounts as finished goods. Further, the method is advantageous in that the feeding rates of the respective raw materials are not limited because the roll-type feeder is used.

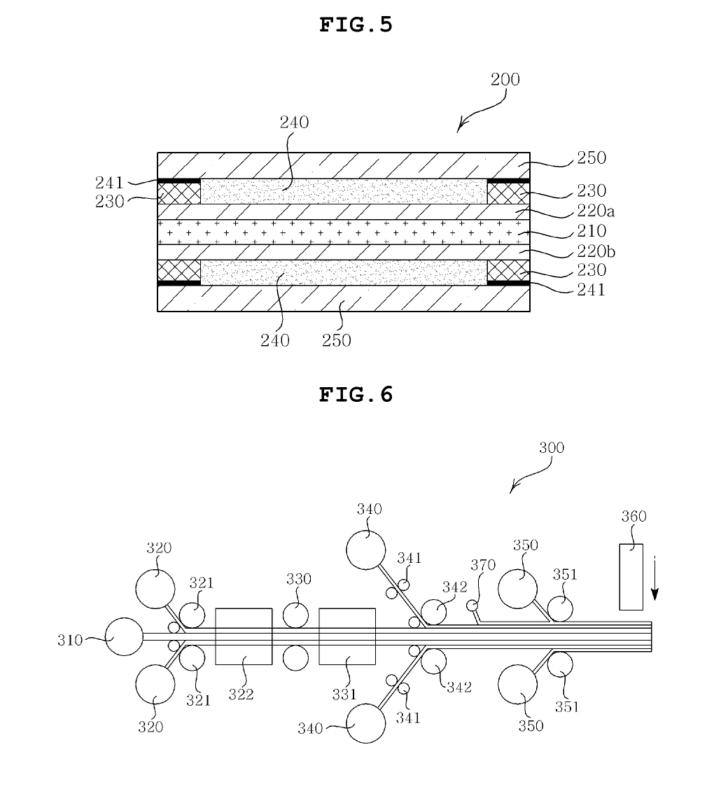

FIG. 5 is a schematic sectional view showing a touch screen manufactured by the method shown in FIG. 4. As shown in FIG. 5, the touch screen 200 includes: a PET film 210; upper and lower substrates 220a and 220b formed on both sides of the PET film 210 and formed of transparent conductive polymer electrodes; conductive patterns 230 printed along both edges of the upper and lower substrates 220a and 220b; OCA films 240, as adhesive layers, formed on the upper and lower substrates 220a and 220b excluding the conductive patterns 230; flexible printed cable connection holes formed on the conductive patterns 230; and protective films 250 formed on the flexible printed cable connection holes. Further, as described above, a three-layered touch screen can be realized by additionally providing supply lines.

FIG. 6 is a schematic view showing an apparatus for manufacturing a touch screen according to a second embodiment of the present invention. The apparatus 300 for manufacturing a touch screen, shown in FIG. 6, is used to manufacture a touch screen for mobile phones, and further includes a cover (window) sheet supply unit 370 in addition to the apparatus 100 for manufacturing a touch screen, shown in FIG. 3.

More concretely, the apparatus 300 for manufacturing a touch screen includes a PET film supply unit 310, transparent conductive polymer electrode supply units 320, transparent conductive polymer electrode printing units 321, conductive pattern printing units 330, drying chambers 322 and 331, adhesive supply units 340, flexible printed cable connection hole forming units 341, a window sheet supply unit 370, protective film supply units 350, and a cutting unit 360.

Here, the window sheet supply unit 370 is provided between the adhesive supply unit 340 and the protective film supply unit 350, and serves to supply a window sheet. Further, the window sheet may be formed of at least one selected from among a hard coating layer, a PET film, a primer layer, a printing and black masking layer, an anti-finger layer, an anti-refractive layer and an antireflective layer.

The apparatus 300 for manufacturing a touch screen further includes press rotating rolls 351 located next to the protective film supply units 350.

Further, the transparent conductive polymer electrode supply units 320 serve to stably and continuously supply conductive polymer materials in order to allow the transparent conductive polymer electrode printing units 321 to work easily.

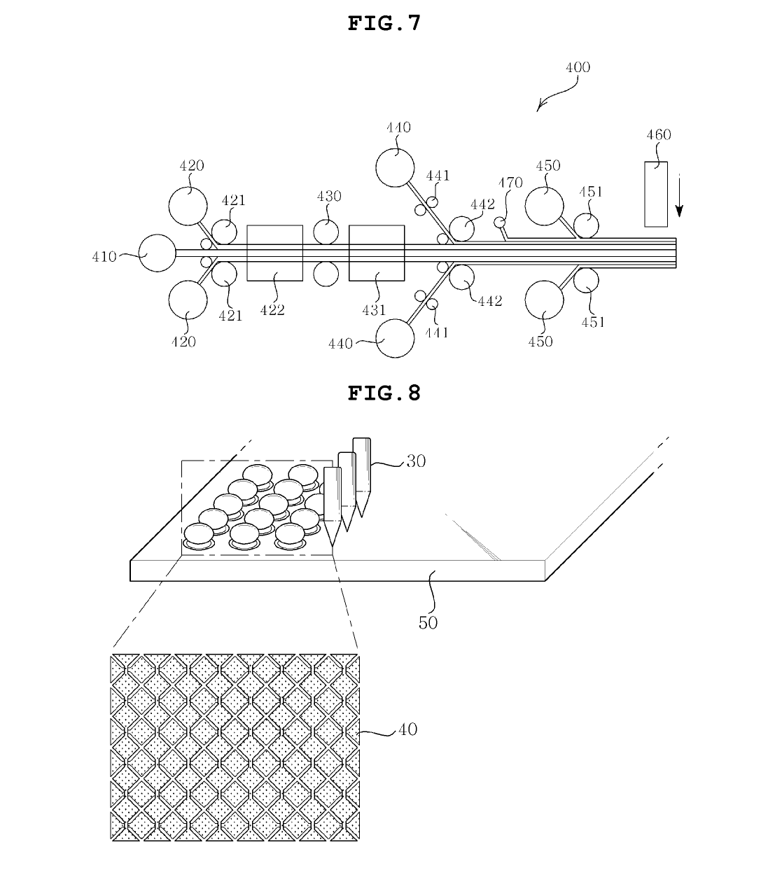

FIG. 7 is a schematic view showing an apparatus for manufacturing a touch screen according to a third embodiment of the present invention. The apparatus 400 for manufacturing a touch screen, shown in FIG. 7, is used to manufacture a touch screen for monitors, and further includes a sheet supply unit 470 in addition to the apparatus 100 for manufacturing a touch screen, shown in FIG. 3.

More concretely, the apparatus 400 for manufacturing a touch screen includes a PET film supply unit 410, transparent conductive polymer electrode supply units 420, transparent conductive polymer electrode printing units 421, conductive pattern printing units 430, drying chambers 422 and 431, adhesive supply units 440, flexible printed cable connection hole forming units 441, a sheet supply unit 470, protective film supply units 450, and a cutting unit 460.

Here, the sheet supply unit 470 is provided between the adhesive supply unit 440 and the protective film supply unit 450, and serves to supply a sheet.

The apparatus 400 for manufacturing a touch screen further includes press rotating rolls 451 located next to the protective film supply units 450.

Further, the sheet may be formed of any one selected from among a hard coating layer, an anti-refractive layer, an antireflective layer, and combinations thereof.

Further, the transparent conductive polymer electrode supply units 420 serve to stably and continuously supply conductive polymer materials in order to allow the transparent conductive polymer electrode printing units 421 to work smoothly.

The above-mentioned methods of manufacturing a touch screen are methods of manufacturing a touch screen using a capacitive overlay manner, and can be performed without an air gap. More concretely, the touch screen manufactured by these methods sequentially includes a window sheet/an OCA film/a PET film/a conductive polymer layer/a pressurized conductive sheet layer/a conductive polymer layer/a PET film or a hard transparent substrate/an OCA film/a protective film. Here, at least one side of the PET film and the window sheet may be hard-coated.

Further, in the method of manufacturing a touch screen using a capacitive overlay manner, upper and lower electrodes are applied on both sides of one PET film, but, in the method of manufacturing a touch screen using an air gap, a pressurized conductive sheet layer is interposed between PET films, each being coated with a conductive polymer layer.

Further, in the method of manufacturing a touch screen using a capacitive overlay manner, during a drying process, ironing is performed at a temperature of 100˜170, thus improving uniform conductivity, moisture resistance, heat resistance, durability and stability to contraction. The conditions for drying can be controlled by controlling the production rate, increasing drying lines or adjusting the drying temperature.

As described above, the method and apparatus for manufacturing a touch screen according to the present invention is advantageous in that it can be automated by a roll-type feeder or a sol-type feeder, in that it can solve the problem of it being difficult to machine one side of the touch screen while protecting the other side thereof and can realize a machining process together with a printing process, in that it can efficiently improve the productivity of the touch screen by controlling the rotation speed of a roll-type feeder and can produce the touch screen in large amounts as finished goods, and in that a conductive polymer film having conductivity, moisture resistance, heat resistance, durability and stability to contraction can be prepared through a sufficient drying process, thus improving the performance of the touch screen.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

Simple modifications, additions and substitutions of the present invention belong to the scope of the present invention, and the specific scope of the present invention will be clearly defined by the appended claims.

What is claimed is:

1. A method of manufacturing a touch screen, comprising:
supplying a PET film;
supplying and printing transparent conductive polymer electrodes on both sides of the PET film;
printing conductive patterns on the transparent conductive polymer electrodes;
supplying an adhesive to the transparent conductive polymer electrodes to form an adhesive layer;
supplying a protective film to the adhesive layer; and
cutting a laminate composed of the PET film, the printed transparent conductive polymer electrodes, the conductive patterns, the adhesive layer and the protective film.

2. The method of manufacturing a touch screen according to claim 1, further comprising: cutting a predetermined portion of the adhesive layer, the predetermined portion corresponding to a position at which flexible printed cables are connected to the conductive patterns.

3. The method of manufacturing a touch screen according to claim 1, wherein the adhesive layer is made of one selected from among an optical clear adhesive (OCA) or a liquid adhesive.

4. The method of manufacturing a touch screen according to claim 1, wherein the supplying of the PET film, the supplying of the transparent conductive polymer electrodes, the supplying of the adhesive and the supplying of the protective film are performed by a roll-type feeder or a sol-type feeder.

5. The method of manufacturing a touch screen according to claim 1, wherein the transparent conductive polymer electrodes are printed on the PET film such that each of the transparent conductive polymer electrodes is composed of a plurality of electrode units which are arranged to have a stripe pattern or no pattern in order to improve transparency and each of the electrode units has one shape selected from among diamond, bar, cone, triangle, ellipse, square, rectangle, circle and polygon shapes.

6. The method of manufacturing a touch screen according to claim 1, wherein the conductive patterns are formed of one selected from among Ag-paste, a conductive polymer, gold, and a nanosized conductive material.

7. The method of manufacturing a touch screen according to claim 1, wherein the printing of the conductive patterns is performed by a coating roll or a silk screen.

8. The method of manufacturing a touch screen according to claim 1, further comprising: vertically hot-pressing the transparent conductive polymer electrodes after the printing of the conductive patterns.

9. The method of manufacturing a touch screen according to claim 1, further comprising:
drying the transparent conductive polymer electrodes after the supplying and printing of the transparent conductive polymer electrodes and after the printing of the conductive patterns.

10. The method of manufacturing a touch screen according to claim 9, wherein the drying of the transparent conductive polymer electrodes is performed at a temperature of 60˜150 for 1˜30 minutes.

11. The method of manufacturing a touch screen according to claim 9, wherein the drying of the transparent conductive polymer electrodes is performed using any one selected from among hot drying, UV drying, IR drying and combinations thereof.

12. The method of manufacturing a touch screen according to claim 1, further comprising: supplying a window sheet to the adhesive between supplying of the adhesive and the supplying of the protective film.

13. The method of manufacturing a touch screen according to claim 12, wherein the window sheet is formed of at least one selected from among a hard coating layer, a PET film, a primer layer, a printing and black masking layer, an anti-finger layer, an anti-refractive layer and an anti-reflective layer.

14. The method of manufacturing a touch screen according to claim 1, further comprising: supplying a sheet to the adhesive between supplying of the adhesive and the supplying of the protective film.

15. The method of manufacturing a touch screen according to claim 14, wherein the sheet is formed of any one selected from among a hard coating layer, an anti-refractive layer, an antireflective layer, and combinations thereof.

16. The method of manufacturing a touch screen according to claim 1, further comprising: forming a hard coating layer on at least one side of the PET film using a coating roll before the supplying of the transparent conductive polymer electrodes.

17. An apparatus for manufacturing a touch screen, comprising:
a PET film supply unit for supplying a PET film;
a transparent conductive polymer electrode supply and printing unit for forming a transparent conductive polymer electrode on the PET film;
a conductive pattern printing unit for printing a conductive pattern on the transparent conductive polymer electrode;
a drying chamber for drying the PET film, the transparent conductive polymer electrode and the conductive pattern;
an adhesive supply unit for supplying an adhesive to the transparent conductive polymer electrode to form an adhesive layer;
a protective film supply unit for supplying a protective film to the adhesive layer and the conductive pattern; and
a cutting unit for cutting a laminate composed of the PET film, the printed transparent conductive polymer electrode, the conductive pattern, the adhesive layer and the protective film.

18. The apparatus for manufacturing a touch screen according to claim 17, further comprising: a cutting unit for cutting a predetermined portion of the adhesive layer, the predetermined portion corresponding to a position at which flexible printed cables are connected to the conductive pattern.

19. The apparatus for manufacturing a touch screen according to claim 17, wherein the supplying of the PET film, the supplying of the transparent conductive polymer electrode, the supplying of the adhesive and the supplying of the protective film are performed by a roll-type feeder or a sol-type feeder.

20. The apparatus for manufacturing a touch screen according to claim 17, wherein the transparent conductive polymer electrode is formed by sequentially printing and laminating a transparent electrode, a transparent insulator and a transparent conductive polymer electrode on a hard substrate composed of a flexible film such as a PET (polyethyleneterephthalate) or PEN (polyethylene naphthalate) film, glass, reinforced glass, PMMA (polymethylmethacrylate), PC (polycarbonate), COC (cyclic olefin copolymer) and BOPS (biaxially oriented polystyrene).
